(19) United States
(12) Patent Application Publication
(10) Pub. No.: US 2018/0367242 A1
(43) Pub. Date: Dec. 20, 2018

(54) HE-SIG-B MCS VALUE ADAPTATION FOR MULTI-USER TRANSMISSION

(71) Applicant: QUALCOMM Incorporated, San Diego, CA (US)

(72) Inventors: Ahmed Ragab ELSHERIF, Santa Clara, CA (US); Srinivas KATAR, Freemont, CA (US)

(21) Appl. No.: 15/623,981

(22) Filed: Jun. 15, 2017

(51) Int. Cl. H04L 1/00; H04B 7/0452

(52) U.S. Cl. CPC H04L 1/0034; H04L 1/0011; H04L 1/0005; H04B 7/0452

(57) ABSTRACT

Certain aspects of the present disclosure relate to determining a signaling field modulation and coding scheme (MCS) value for communicating information in a signaling field of a frame to a plurality of user devices. Certain aspects of the present disclosure provide a method for wireless communications by an access point (AP). The method includes determining a signaling field modulation and coding scheme (MCS) value for communicating information in a signaling field of a frame to a plurality of user devices based on one or more data MCS values for communicating payload data of the frame to the plurality of user devices. The method further includes transmitting the frame to the plurality of user devices using the determined signaling field MCS value for the signaling field.

### BACKGROUND

### Field of the Disclosure

Certain aspects of the present disclosure generally relate to wireless communications and, more particularly, to techniques for adapting a modulation and coding scheme (MCS) value (e.g., index value) used for communicating a signaling field of a frame based on a MCS value used for communicating payload data of the frame.

### Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communication systems. MIMO technology has been adopted in several wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee.

An example of an IEEE 802.11 standard that implements the MIMO technology is 802.11ax. 802.11ax has two modes of operations: a single user mode and a multi-user mode. The multi-user (MU) mode allows for simultaneous operation of multiple non-AP (non-access point) stations. Under the MU mode of operation, the 802.11ax standard also specifies two different methods of multiplexing a higher number of users including MU-MIMO and MU-OFDMA. The embodiments described herein relate to both methods of multiplexing, MU-MIMO and MU-OFDMA, such as under the 802.11ax standards or in other suitable wireless communication systems.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Certain aspects of the present disclosure provide a method for wireless communications by an access point (AP). The method includes determining a signaling field modulation and coding scheme (MCS) value for communicating information in a signaling field of a frame to a plurality of user terminals based on one or more data MCS values for communicating payload data of the frame to the plurality of user terminals. The method further includes transmitting the frame to the plurality of users using the determined signaling field MCS value for the signaling field.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an example wireless communications network, in accordance with certain aspects of the present disclosure.

FIG. 2 is a block diagram of an example access point (AP) and user terminals, in accordance with certain aspects of the present disclosure.

FIG. 3 is a block diagram of an example wireless device, in accordance with certain aspects of the present disclosure.

FIG. 4 illustrates an example of a High Efficiency Physical Layer Convergence Procedure (PLCP) Protocol Data Unit (PPDU) frame format, in accordance with certain aspects.

FIG. 5 illustrates an example HE-SIG-B signaling field, in accordance with certain aspects.

FIG. 6 illustrates an exemplary table illustrating the overhead incurred for the transmission of information contained in the HE-SIG-B signaling field, according to aspects of the present disclosure.

FIG. 7 illustrates an exemplary table mapping various ranges of MCS values for communicating payload data of a frame to a set of HE-SIG-B MCS functions, according to aspects of the present disclosure.

FIG. 8 illustrates an exemplary table of MCS index values, according to aspects of the present disclosure.

FIG. 9 illustrates exemplary tables mapping various ranges of MCS values for communicating payload data of a frame to a set of HE-SIG-B MCS functions based on the number of user terminals, according to aspects of the present disclosure.

FIG. 10 illustrates an exemplary table generally mapping various ranges of MCS values for communicating payload data of a frame to a set of HE-SIG-B MCS functions, according to aspects of the present disclosure.

FIG. 11 illustrates example operations for wireless communications by an access point, according to aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Certain aspects of the present disclosure are described with respect to the IEEE 802.11ax wireless communication standard, and utilizing terminology associated with IEEE 802.11ax. However, it should be noted that the techniques and aspects described herein may also be used with other suitable wireless communication standards.

In some wireless communication standards, signaling fields contain important information for configuring the receiver(s). Accordingly, they may be transmitted with a relatively conservative modulation and coding scheme (MCS) (e.g., BPSK modulation) to maximize the probability of reception and decoding. In certain wireless communication standards, however, such as 802.11ax, a large volume of information may need to be transmitted through signaling fields for a large number of users. The transmission of larger payload for signaling fields under these circumstances may result in significant communication overhead due to low throughput if conservative MCS transmissions are maintained for those signaling fields. As described in further detail below, instead of maintaining a fixed MCS for transmission of signaling fields of a particular PPDU, the MCS may be adapted based on various factors, including the MCS used for transmission of the associated data portion of the same PPDU, a total number of users associated with the PPDU, an error rate in transmission/reception of the PPDU, etc., or any combination of the above. The adaptive MCS for signaling field transmissions may improve throughput when particular circumstances and channel conditions allow for more aggressive MCS.

Aspects of the present disclosure generally relate to determining, using an access point (AP), a signaling field modulation and coding scheme (MCS) value for communicating information in a signaling field of a frame to a plurality of user terminals based on one or more data MCS values for communicating payload data of the frame to the plurality of user terminals. In certain aspects, the AP may then transmit the frame to the plurality of user terminals using the determined signaling field MCS value for the signaling field.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the AT may be a wireless node. Such wireless node may provide, for example, connectivity for or to a network (e.g., a wide area network such as the Internet or a cellular network) via a wired or wireless communication link.

AN EXAMPLE WIRELESS COMMUNICATION SYSTEM

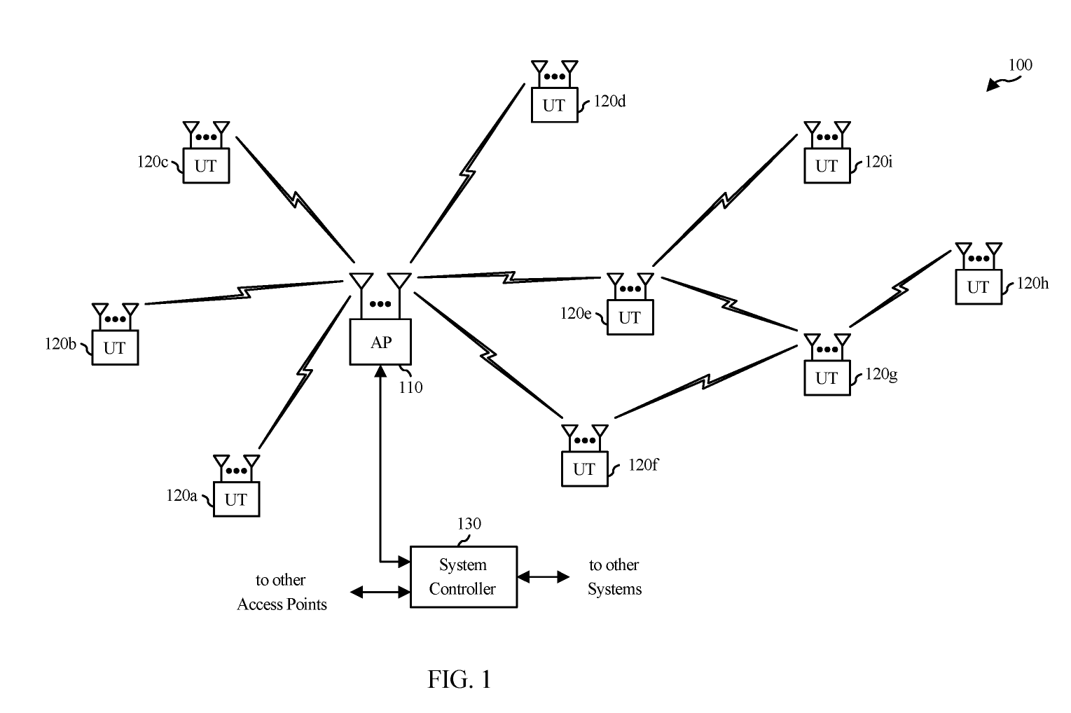

FIG. 1 illustrates a system 100 in which aspects of the disclosure may be performed. For example, AP 110 may determine a signaling field MCS value for communicating information in a signaling field of a frame to a plurality of user terminals 120 based on one or more data MCS values for communicating payload data of the frame to the plurality of user terminals. In certain aspects, AP 110 may then transmit the frame to user terminals 120 using the determined signaling field MCS value for the signaling field.

The system 100 may be, for example, a multiple-access multiple-input multiple-output (MIMO) system 100 with access points and user terminals. The system 100 may further support multi user (MU)-MIMO and MU-OFDMA communications. For simplicity, only one access point 110 is shown in FIG. 1. An AP is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≥K≥1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≥1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

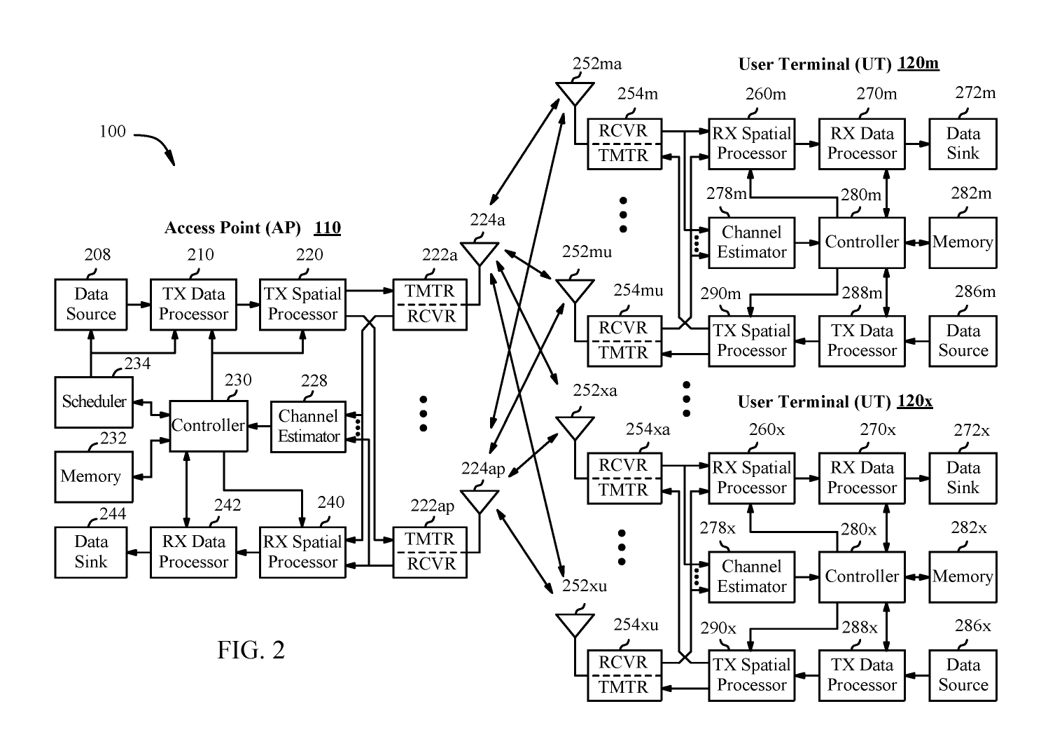

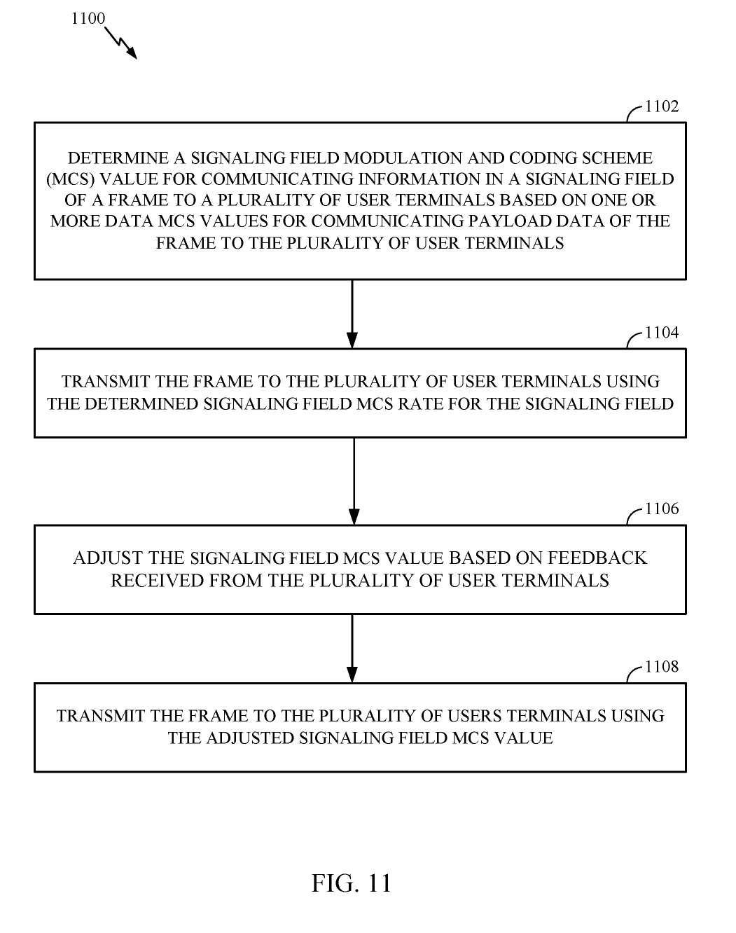

FIG. 2 illustrates exemplary components of the AP 110 and UT 120 illustrated in FIG. 1, which may be used to implement aspects of the present disclosure. One or more components of the AP 110 and UT 120 may be used to practice aspects of the present disclosure. For example, antenna 252, Tx/Rx 254, processors 260, 270, 288, and 290, and/or controller 280 may be used to perform the operations described herein and illustrated with reference to FIG. 11. Antenna 224, Tx/Rx 222, processors 210, 220, 240, and 242, and/or controller 230 may be also used to perform the operations described herein and illustrated with reference to FIG. 11.

FIG. 2 illustrates a block diagram of access point 110 and two user terminals 120m and 120x in a MIMO system 100. The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the MCS associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the AP 110.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. For example, the access point 110 may receive data from the Nᵤₚ user terminals using random access procedures on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the MCS associated with the data rate selected for the user terminal. As described herein, TX data processor 210 and/or controller 230 may determine an MCS index value for data frames, and fields thereof, transmitted by AP 110 to user terminals. As further described herein, TX data processor 210 and/or controller 230 may also use an MCS index value for the data payload field of the frame to determine an MCS index value for a signaling field of the frame. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals. The decoded data for each user terminal may be provided to a data sink 272 for storage and/or a controller 280 for further processing.

At each user terminal 120, N_{ut,m} antennas 252 receive the Nₐₚ downlink signals from access point 110. For example, each user terminal 120 may receive the broadcast message from the access point 110 with acknowledgements for multiple user terminals and process the acknowledgement for the given user terminal 120. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

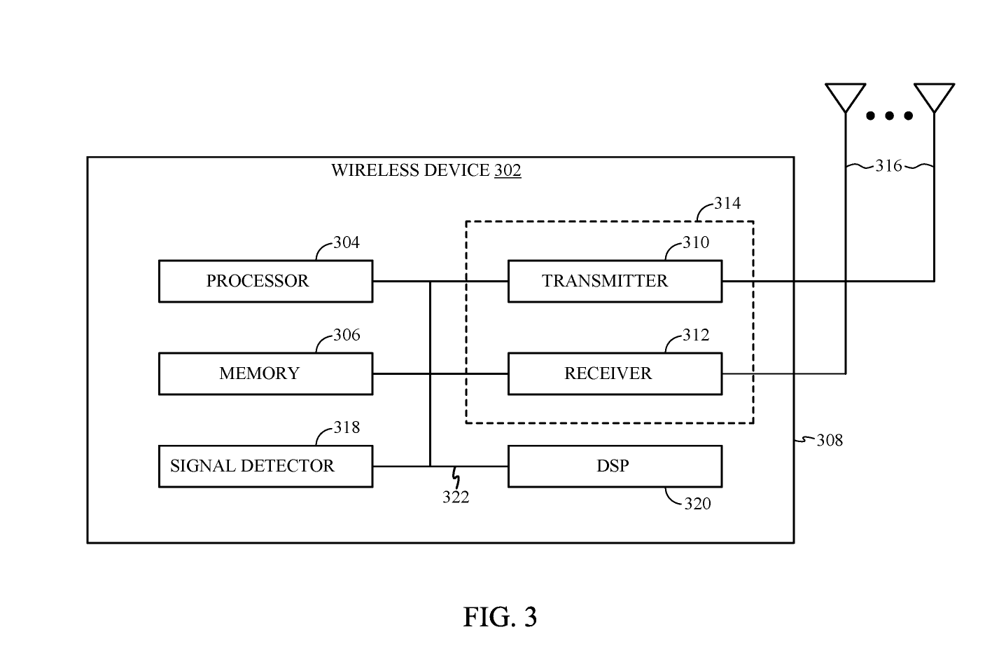

FIG. 3 illustrates various components that may be utilized in a wireless device 302 that may be employed within the MIMO system 100. The wireless device 302 is an example of a device that may be configured to implement the various methods described herein. For example, the wireless device may implement operations 1100 illustrated in FIG. 11. The wireless device 302 may be an access point 110 or a user terminal 120. For example, the wireless device 302 may be an access point 110 configured to determine a signaling field MCS value for communicating information in a signaling field of a frame to UTs 120 based on one or more data MCS values for communicating payload data of the frame to UTs 120. Also, the wireless device 302 may be a user terminal 120 configured to send block acknowledgements (BAs) to AP 110 in response to receiving frames transmitted by AP 110.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein. For example, the processor 304 may perform random access procedures, generate messages with multiple acknowledgements, process acknowledgements, etc.

In addition, as described herein, in some embodiments, processor 304 may determine an MCS index value for data frames, and fields thereof, transmitted by AP 110 to user terminals. As further described herein, processor 304 may also use an MCS index value for the data payload field of the frame to determine an MCS index value for a signaling field of the frame.

The wireless device 302 may also include a housing 308 that may include a transmitter 310 and a receiver 312 to allow transmission and reception of data between the wireless device 302 and a remote node. In some embodiments, transmitter 310 may transmit data frames to user terminals using an MCS index value determined for each data frame, as described herein. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers. For example, the transceiver 314 may send data using random access procedures, receive data, send broadcast messages with a plurality of acknowledgement, receive broadcast messages with a plurality of acknowledgements, etc.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Example HE-SIG-B Value Adaptation For Multi-User Transmission

As described above in relation to FIG. 1, access point 110 and user terminals 120 may communicate together at any given moment on the downlink and uplink. This data communication between access point (AP) 110 and user terminals (UTs) 120 of system 100 may be through various well defined data frame structures. In general, a data frame comprises a Physical Layer Convergence Procedure (PLCP) Protocol Data Unit (PPDU), a frame header, and a payload.

Under the 802.11ax standards, a high-efficiency multi-user (HE-MU) PPDU frame format has been defined for downlink (DL) multi-user (MU) transmissions, including DL MU MIMO and DL MU OFDMA transmissions. The HE-MU PPDU frame may be transmitted from AP 110 to UTs 120 and include payloads for UTs 120.

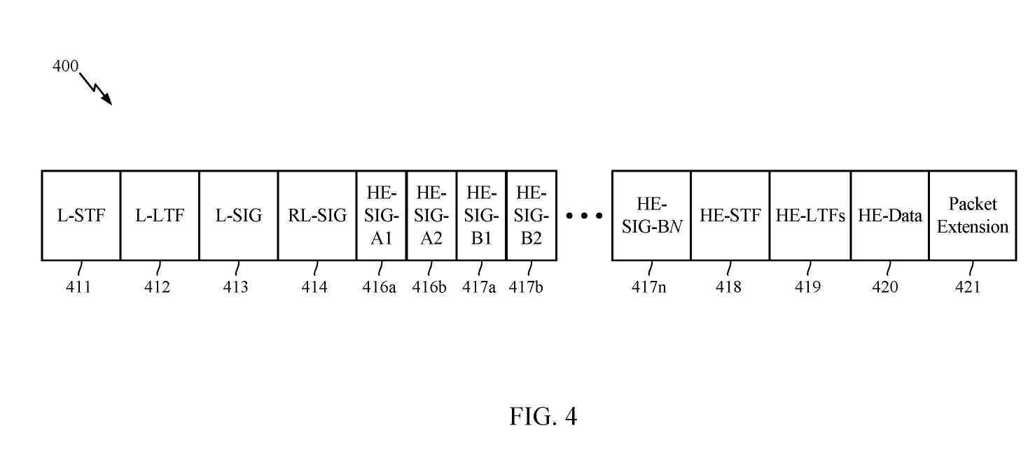

FIG. 4 shows an example HE-MU PPDU frame format 400 comprising a legacy short training field (L-STF) 411, a legacy long training field (L-LTF) 412, a legacy signal field (L-SIG) 413, a repeat legacy signal field (RL-SIG) 414, HE signal A1 field (HE-SIG-A1) 416a, a HE signal A2 field (HE-SIG-A2) 416b, HE signal B1 field (HE-SIG-B1) 417a, a HE signal B2 field (HE-SIG-B2) 417b, a HE signal BN field (HE-SIG-BN) 417n, a HE short training field (HE-STF) 418, a HE long training field (HE-LTFs) 419, a HE-data payload field (HE-Data) 420, and a Packet Extension field 421. HE-data payload field (HE-Data) 420 includes data, which, in contrast to signaling and control information and overhead, is the actual data intended to be received by a UT 120.

As shown in FIG. 4, the HE-MU PPDU frame format 400 includes a signaling field called the HE-SIG-B field 417. Though HE-SIG-B field 417 is shown as including multiple fields HE-SIG-B1 417a, HE-SIG-B2 417b HE-SIG-BN 417n, in some aspects, the HE-SIG-B field 417 may only include one such field. For example, such as with respect to where the HE-MU PPDU is communicated as a DL MU MIMO transmission, or where the HE-MU PPDU has a bandwidth below a threshold (e.g., 40 MHz) the HE-SIG-B field 417 of the HE-MU PPDU may be transmitted in a single channel, which may be referred to as a HE-SIG-B content channel.

In certain aspects, such as where the HE-MU PPDU has a bandwidth equal to or above a threshold (e.g., 40 MHz), or for where the HE-MU PPDU is communicated as a DL MU OFDMA transmission, the HE-SIG-B field 417 may be transmitted in multiple channels, each of which may be referred to as a HE-SIG-B content channel. For example, the HE-SIG-B field 417 may be separately encoded on each 20 MHz band the HE-MU PPDU is transmitted in. In certain aspects, the HE-SIG-B field 417 (e.g., each of HE-SIG-B field 417a-417n) may include a common information block field that includes information common for all UTs 120 for which data is included in the HE MU PPDU in the bandwidth of the HE-SIG-B content channel (e.g., for DL MU OFDMA or for DL MU OFDMA in combination with DL MU MIMO). In certain aspects, the HE-SIG-B field 417 does not include a common information block field, such as when signaling a full bandwidth DL MU-MIMO PPDU. In certain aspects, the HE-SIG-B field 417 (e.g., each of HE-SIG-B field 417a-417n) may include a user specific information field (interchangeably referred to as “user block field”), containing user specific information for each UT 120 for which data is included in the HE-MU PPDU (e.g., for DL MU MIMO) (or corresponding bandwidth of the HE-SIG-B content channel (e.g., for DL MU OFDMA)). The user specific information for each UT 120 may allow each UT 120 to receive and decode its own payload, and may follow the common information block field. The common information block field and the user block field (e.g., of each of HE-SIG-B field 417a-417n) may also be referred to together as a HE-SIG-B content channel.

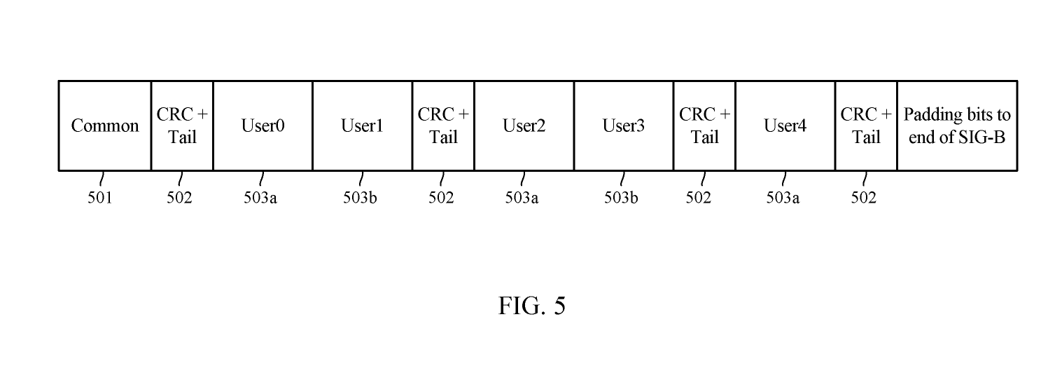

FIG. 5 shows exemplary HE-SIG-B content channel 500 (e.g., corresponding to one of HE-SIG-B field 417a-417n) including a common information block field 501 and user specific information field field 503. In certain aspects, the common information block field 501 may be included only for DL MU OFDMA transmissions. The common information block field 501 carries information common for all UTs 120 for which data is included in the bandwidth corresponding to the HE-SIG-B content channel such as information related to resource unit allocation, which may, for example, be used for assigning different resources (e.g. frequency resources) to different UTs 120. Common information block field 501 may be followed by a cyclic redundancy check (CRC) and tail block 502 that includes a CRC and tail bits. CRC may be code added to data, such as the common information block field 501, to be used for detecting errors occurring during the transmission or reception of the data. Tail bits also may be a fixed sequence of bits added to the end of a block of data, such as the common information block field 501, to reset a convolutional encoder to a predefined state. As described above and also shown in FIG. 5, HE-SIG-B content channel 500 may also include one or more user specific information fields 503, each including up to two user block fields (e.g. 503a and 503b) containing information for respective UTs 120, enabling them to decode their payload included in the HE-MU PPDU frame 400. For example, as shown in FIG. 5, each user block field 503x may correspond to a different UT 120 (User0, User1, etc.). The number of user block fields 503x may depend on the number of UTs 120 for which data is included in the bandwidth corresponding to the HE-SIG-B content channel. Accordingly, as shown in FIG. 5, the HE-SIG-B content channel may have 5 user block fields User0, User1, User2, User 3, and User4 corresponding to 5 UTs 120 for which data is included in the bandwidth corresponding to the HE-MU content channel.

In certain aspects, the number of bits included in common information block field 501 may depend on the HE-MU PPDU bandwidth. For example, using a 20 MHz or 40 MHz bandwidth, the number of bits included may be 18, while the number of bits may jump to 27 bits when the bandwidth is 80 MHz, or 43 bits when the bandwidth is 160 MHz. Moving now to the user block fields 503x, each user block field 503x (e.g. 503a for User0) may include 21 bits of information. Accordingly, for every 2 users (e.g. User0+User1) there may be 42 bits of information (e.g. 21+21) followed by 10 bits of information for the CRC and tail block 502 corresponding to the last UT 120. In such cases, the total number of bits for an even number of UTs 120 may be (21+21+10)*(K/2)=52*(K/2) bits, where K is the number of UTs 120 or user block fields 503x in an HE-SIG-B content channel, and the total number of bits for an odd number of UTs 120 may be (21+21+10)*(K−1)/2+(21+10)=52*(K−1)/2+31 bits. For instance, as shown in FIG. 5, the total number of bits in the 5 user block fields 503x for the 5 UTs 120 may be 135, i.e., (52*(K−1)/2+31).

In certain aspects, various data rates may be used for the transmission of HE-MU PPDU frame 400. With the introduction of IEEE 802.11n wireless standards, in some cases, MCSs have been used to determine the data rate of a wireless connection using high-throughput OFDM (HT-OFDM). HT-OFDM may use parameters such as channel size, number of spatial streams, coding method, modulation technique, guard interval, etc. to determine the data rate. Each MCS is a combination of these parameters. Accordingly, in some cases, MCS index values are defined, each corresponding to a certain combination of all these parameters used by HT-OFDM. For example, MCS index values may provide possible combinations of the number of spatial streams, modulation type, and coding rate. In some cases, a certain MCS may be negotiated during communication and serve to strike a balance between maximum possible data rate and maximum acceptable error rate.

As an example, MCS index values for 802.11n may range from 0 to 31, each corresponding to a certain combination of parameters including the number of spatial streams, modulation type, coding rate and the data rate, which is further broken down depending on the size of the bandwidth (e.g. 20 MHz, 40 MHz, etc.). In some cases, each of the block fields of HE-MU PPDU frame 400 may have its own MCS index value (“MCS value”). For example, the MCS value used for the HE-Data field 420 may be different than the MCS value used for the HE-SIG-B field 417 (herein after referred to as the HE-SIG-B MCS value). In some cases, the HE-SIG-B MCS value used for HE-SIG-B field 417 may be communicated in the preceding HE-SIG-A 416 field. Under the 802.11ac standards, HE-SIG-B field 417 has, in some cases, been transmitted with a fixed HE-SIG-B MCS value of, for example, 0. In some instances, the fixed MCS value of 0 for signaling fields may improve reliability of decoding the signaling field but may result in lower throughput as less information can be transmitted with lower MCS values.

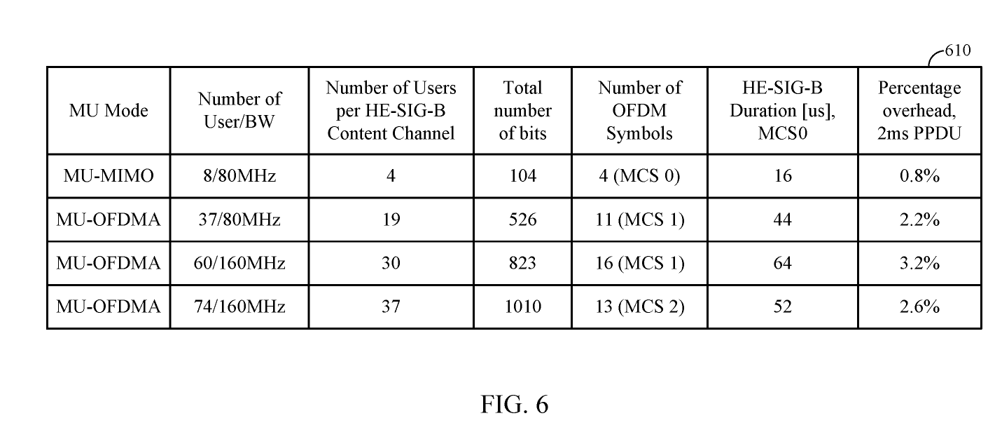

However, under the 802.11ax standards, a larger volume of information may be transmitted through HE-SIG-B field 417 during DL MU transmissions. For example, the overhead for communicating HE-SIG-B for each DL MU PPDU may be significant, especially for a large number of MU users. FIG. 6 illustrates an exemplary table 610 illustrating the overhead incurred for the transmission of information contained in the HE-SIG-B field 417 depending on the number of UTs 120 receiving information under different MU modes (e.g. MU-MIMO, MU-OFDMA, etc.). For example, even if AP 110 uses MCS2 for the HE-SIG-B, the overhead for MU-OFDMA for a 160 MHz bandwidth with 74 users may be 52 micro seconds, which as shown in FIG. 6 represents a 2.6% overhead assuming a 2 millisecond PPDU. This 2.6% overhead, therefore, results in a 2.6% peak throughput drop. Therefore, if HE-SIG-B is always transmitted with a fixed MCS value of 0, the transmission of a certain amount of data may take much longer in duration.

Accordingly, certain embodiments described herein relate to enabling HE-SIG-B MCS value adaptations based on one or more factors to help lower the overhead and enhance the throughput associated with the transmission of HE-SIG-B field 417 under the 802.11ax standards. In some embodiments, a HE-SIG-B MCS value (e.g., for a HE-SIG-B content channel) is adapted (e.g., selected) based on the MCS values used for the data payload field (HE-Data 420) (herein after referred to as DL MU MCS values) of the HE-MU PPDU frame 400 for UTs 120 for which information is included in the HE-SIG-B content channel. In some embodiments, a HE-SIG-B MCS value for a HE-SIG-B content channel is adapted based on the DL MU MCS values as well as the total number of UTs 120 for which information is included in the HE-SIG-B content channel. In some embodiments, a HE-SIG-B MCS value for a HE-SIG-B content channel is adapted based on the DL MU MCS values and/or the total number of UTs 120 for which data is included in the HE-SIG-B content channel in combination with the number of block acknowledgement (BA) failures for UTs 120 for which data is included in the HE-SIG-B content channel.

As described above, in some embodiments, the HE-SIG-B MCS value is adapted based on DL MU MCS values for each UT 120. For example, in certain aspects, DL MU MCS values are adapted by AP 110 for the HE-MU PPDU frame 400 for each UT 120 based on a previous packet error rate (PER) experience. DL MU MCS values reflect the rate that each UT 120 can sustain based on the link with the AP 110 (channel condition, path loss, collision, etc.). Accordingly, as described above, the DL MU MCS value that AP 110 may assign for each UT 120 for which information is included in the HE-SIG-B content channel may be used to determine the HE-SIG-B MCS value for the HE-SIG-B content channel. This is because, at least in some embodiments, the UT 120 that is able to decode the HE MU PPDU with a certain MCS value for the data payload field (HE-Data 420) of the DL MU PPDU may also be able to decode the HE-SIG-B field 417 being transmitted with the same or lower MCS value.

In some embodiments, a function may be provided for deriving a DL MU MCS Metric using DL MU MCS values for UTs 120, and then using the DL MU MCS Metric to derive a HE-SIG-B MCS value. In some embodiments, the function for deriving the DL MU MCS Metric may be designed in a conservative manner to increase the likelihood that all UTs 120 can decode HE-SIG-B field 417. In some other embodiments, the function may be more aggressive resulting in a shorter transmission duration. For example, in some embodiments, the DL MU MCS values for different UTs 120 for which information is included in the HE-SIG-B content channel may be 7, 8, and 9. In such embodiments, a DL MU MCS Metric may be derived using a conservative function, such as DL MU MCS Metric=min(DL−MCS−UTi), designed to output the lowest DL MU MCS value, where DL−MCS−UTi is the DL MU MCS of each UTi for which information is included in the HE-SIG-B content channel. For example, taking the DL MU MCS values of 7, 8, and 9, the function may output the minimum, which is 7. Once a DL MU MCS Metric has been calculated, a function for calculating a HE-SIG-B MCS value for the HE-SIG-B content channel may be selected based on where the calculated DL MU MCS Metric belongs in a table that maps different DL MU MCS Metric ranges to certain functions for deriving HE-SIG-B MCS values.

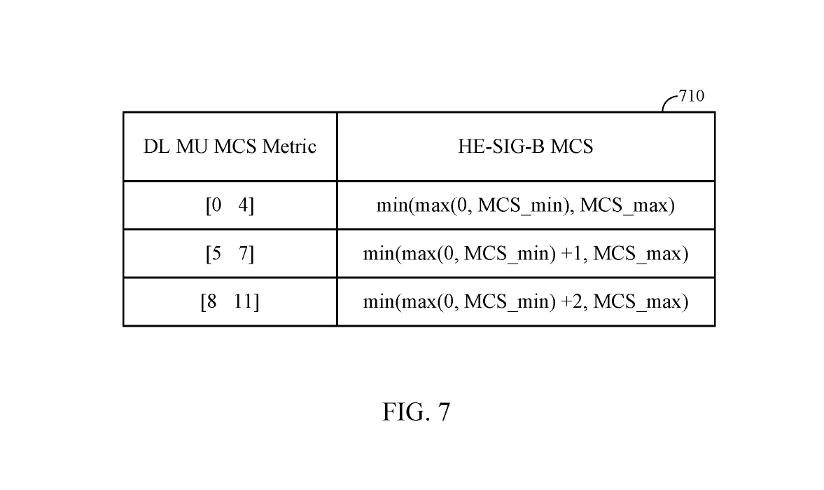

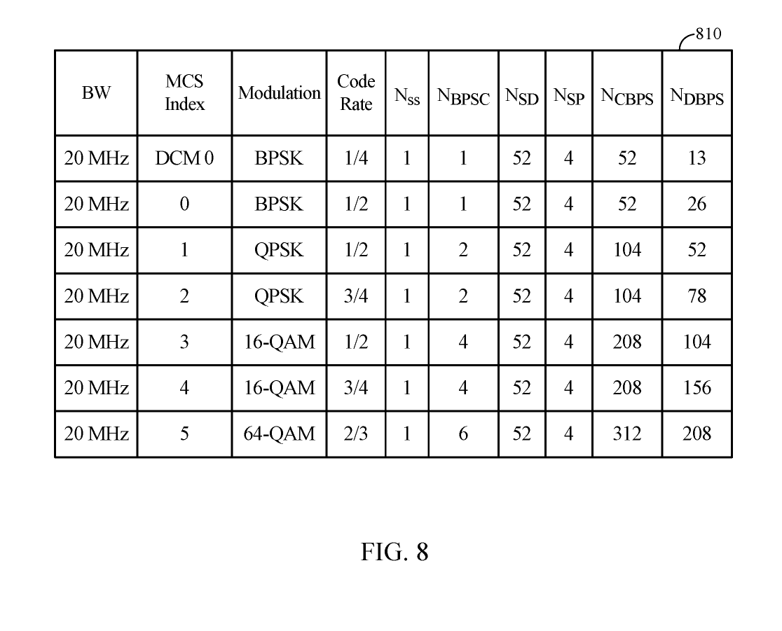

FIG. 7 illustrates an exemplary table 710 mapping various ranges of MCS values for communicating payload data of a frame to a set of functions. Each function uses a calculated minimum HE-SIG-B MCS value (MCS-min) and a maximum HE-SIG-B MCS value (MCS-max) to derive a HE-SIG-B MCS value. In order to calculate a MCS-min for a certain HE-SIG-B content channel, the steps described below, one of which is using table 810 of FIG. 8, may be followed. The first step of deriving a MCS-min, in some embodiments, is calculating the total number of bits included in the HE-SIG-B content channel (e.g., HE-SIG-B content channel 500).

This is accomplished by first calculating a maximum number (K) of user block fields (e.g., 503a, 503b, etc.) across the HE-SIG-B content channel based on RU (resource unit) or user allocation. Next, based on the maximum number (K) of user block fields, the number of bits included in the HE-SIG-B field content channel 500 may be derived by first determining the number of bits included in a common information block field (e.g., 501), if any, and next determining the total number of bits included in all the user block fields (e.g., 503a, 503b, etc.). Starting with calculating the number of bits included in the common information block field (e.g., 501), if the packet (e.g., frame 400) is a DL MU-OFDMA packet or DL MU-OFDMA plus MU-MIMO packet, then the common information block field may, for example, be 18 bits if the bandwidth is 20 MHz or 40 MHZ, 27 bits if the bandwidth is 80 MHz, or 43 bits if the bandwidth is 160 MHz. If the packet is a full bandwidth DL MU-MIMO, the number of bits included in the common information block field is zero because there are no common information block fields in such cases. Moving next to calculating the total number of bits included in all the user block fields (e.g., 503a, 503b, etc.) of the HE-SIG-B field content channel, if the maximum number of user block fields (K) is an even number, then the total number of bits for all the user block fields is 52*(K/2). On the other hand, if the maximum number of user block fields (K) is an odd number, the total number of bits for all the user block fields is 52*(K−1)/2+31.

By adding the number of bits for the common information block field to the total number of bits for all the user block fields, the total number of bits for the HE-SIG-B content channel may be derived. As the next step, a MCS-min may be derived, using table 810 of FIG. 8, such that the number of OFDM symbols for HE-SIG-B content channel is less than or equal to 16. This is because the number of HE-SIG-B symbols in HE-SIG-A (e.g., 416a, 416b, etc.) is 4 bits (i.e. maximum of 16 OFDM symbols). FIG. 8 illustrates an example table including MCS index values, each corresponding to a plurality of parameters under the 802.11ax standards. Such parameters include the size of the bandwidth, the modulation type, the code and data rate, number of bits per OFDM symbol, etc. Using the N_{DBPS} (number of data bits per OFDM symbol), table 810 may then be searched for the 20 MHz bandwidth to find a MCS-min corresponding to less than or equal to 16 OFDM symbols, where the number of OFDM symbols for HE-SIG-B content channel equals the number of bits for the HE-SIG-B content channel divided by N_{DBPS}.

For example, assuming a bandwidth of 20 MHz, the common information block field may carry 18 bits as described above. Also, assuming there are 10 user block fields (K=10), the total number of bits for all the user block fields may then be equal to 260 (i.e., 52*(10/2)=260). As a result, in such an example, the total number of bits for the HE-SIG-B content channel is 278 (i.e., 260+18=278). Performing a table look-up of table 810, the first N_{DBPS} number to consider, that corresponds to the lowest possible MCS value, is 13. However, 278 divided by 13 results in 21.38, which is higher than 16 (i.e., number of OFDM symbols for the HE-SIG-B content channel). Moving down, the next N_{DBPS} number in table 810 is 26. 278 divided by 26 results in 10.69, which is lower than 16. As a result, the MCS value of (0) corresponding to the N_{DBPS} 26 may be picked as the MCS-min. Moving now to MCS-max, under the 802.11ax standards, MCS-max may, in some embodiments, be 5.

Referring back to table 710 of FIG. 7, a HE-SIG-B MCS value may then be derived by inputting the MCS-min and MCS-max, as described above, in each of the functions shown in table 710. For example, using 0 as MCS-min and 5 as MCS-max, function (min (max (0, MCS min), MCS max)), corresponding to the [0-4] DL MU MCS Metric range, results in an HE-SIG-B MCS value of 0. Next, using 0 as MCS-min and 5 as MCS-max, function (min (max (0, MCS min)+1, MCS max)), corresponding to the [5-7] DL MU MCS Metric range, results in an HE-SIG-B MCS value of 1. Further, using 0 as MCS-min and 5 as MCS-max, function (min (max (0, MCS_min)+2, MCS_max)), corresponding to the [8-11] DL MU MCS Metric range, results in an HE-SIG-B MCS value of 2.

Accordingly, as described above in relation to FIG. 7, where the calculated DL MU MCS Metric was 7, a table look-up of table 710 may then result in a HE-SIG-B MCS value of 1 because the DL MU MCS Metric of 7 belongs in the [5-7] DL MU MCS Metric range, which corresponds to HE-SIG-B MCS value of 1. As described above, in some embodiments the function for deriving the DL MU MCS Metric may be more aggressive. For example the function may be DL MU MCS value=avg(DL−MCS−UTi). Accordingly, given MCS values of 7, 8, and 9 for a user, the function above may output the number 8. In the example above, the table look-up of table 710 of FIG. 7 may result in a HE-SIG-B MCS value of 2 because the DL MU MCS value falls in the 8 to 11 range.

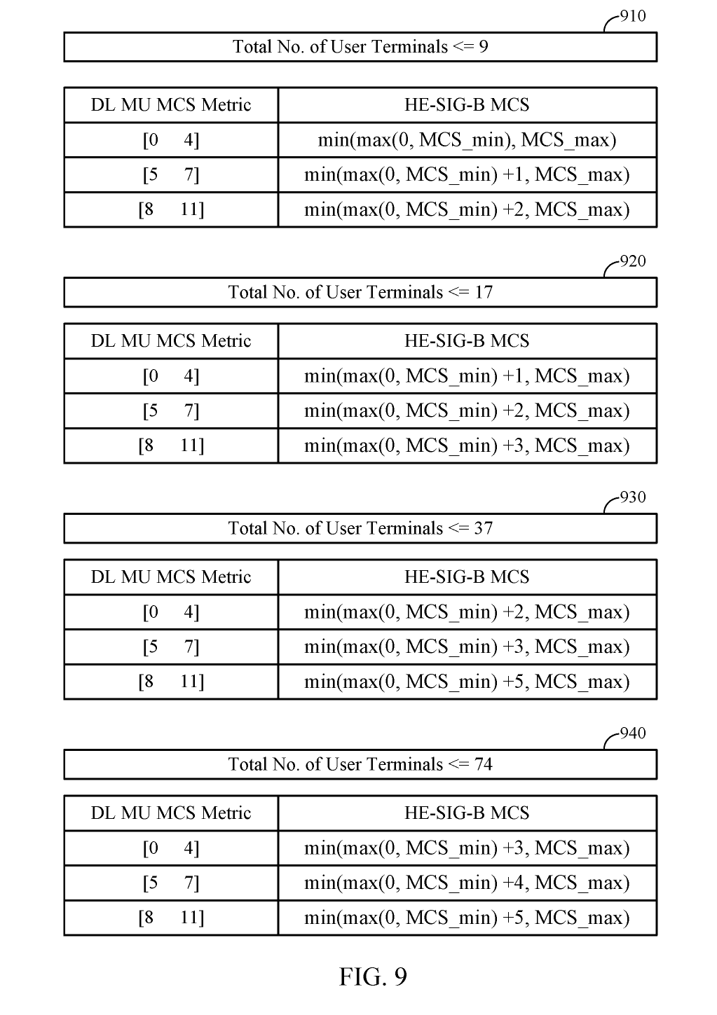

As described above, in some embodiments, the HE-SIG-B MCS value may be adapted as a function of the DL MU MCS Metric and also the number of MU UTs 120. For example, once a DL MU MCS Metric is calculated based on a function, the DL MU MCS Metric may be mapped to a HE-SIG-B MCS function in a table based on the total number of MU UTs 120 for which information is included in the HE-SIG-B content channel. In such embodiments, multiple tables may be stored by an AP 110, wherein each table may assign a different HE-SIG-B MCS function to the different DL MU MCS Metric ranges based on the total number of UTs 120. FIG. 9 illustrates exemplary tables mapping various ranges of MCS values for communicating payload data of a frame to a set of functions based on the number of UTs 120. As described in relation to FIG. 7, each function in tables 910, 920, and 930 uses a MCS-min and MCS-max, calculated or defined as described above, to derive a HE-SIG-B MCS value. For instance, table 910 of FIG. 9 shows a set of HE-SIG-B MCS functions corresponding to multiple DL MU MCS Metric ranges for a number of UTs 120 equal to or less than 9. Table 920 shows HE-SIG-B MCS functions for 17 or fewer UTs 120, table 930 shows HE-SIG-B MCS functions for 34 or fewer UTs 120, and table 940 shows HE-SIG-B MCS values for 74 or fewer UTs 120 (for 160 MHz DL MU OFDMA).

As an example, as shown in FIG. 9, if the total number of UTs 120 is less than 9, then function (min (max (0, MCS min)+1, MCS max)) may be assigned to the DL MU MCS Metric range of 5 to 7. However, if the total number of UTs 120 is somewhere between 9 to 17, then function (min (max (0, MCS min)+2, MCS_max))may be assigned to the DL MU MCS Metric range of 5 to 7. As described above in relation to FIGS. 7 and 8, by using a defined MCS-min and MCS-max in each of the functions of table 710, a corresponding HE-SIG-B value may be derived for each DL MU MCS Metric range.

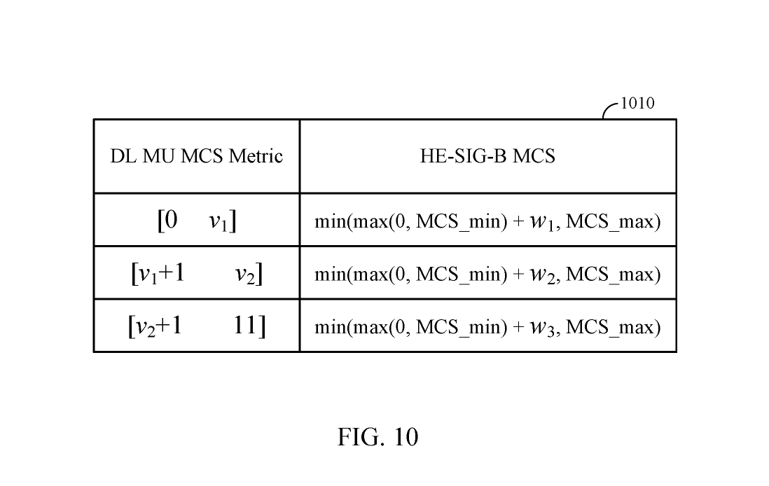

Accordingly, in such embodiments, the HE-SIG-B MCS adaptation may be performed not only based on the DL MU MCS values but also the total number of UTs 120 for which information is included in the HE-SIG-B content channel. It is important to note that tables 910-940 described in FIG. 9 are mere examples and should not be construed to limit the present disclosure. FIG. 10 illustrates an exemplary table 1010 generally mapping various ranges of MCS values for communicating payload data of a frame to a set of HE-SIG-B MCS functions. More specifically, FIG. 10 shows table 1010, where v₂>v₁ and w₃≥w₂≥w₁ and where values of w₃, w₂, w₁ in the corresponding HE-SIG-B MCS functions are adapted based on the number of UTs 120 for which information is included in the HE-SIG-B content channel. As described above in relation to FIG. 8, prior to using table 1010, a MCS-min and a MCS-max may be derived for calculating the HE-SIG-B MCS values by using the HE-SIG-B MCS functions shown in table 1010. A certain calculated DL MU MCS metric, belonging to the DL MU MCS metric ranges, may then be mapped to a corresponding HE-SIG-B MCS value.

In such embodiments, the values of v₁, v₂, w₁, w₂, w₃ may also be fine-tuned based on performance. In some embodiments, instead of the number of UTs 120, the DL MU MCS Metric ranges may be mapped to a HE-SIG-B MCS value in each table based on different bandwidth ranges.

As described above, in some embodiments, HE-SIG-B MCS values may be adapted based on the DL MU MCS values used for the data payload field (HE-Data 420) and/or the total number of UTs 120 for which information is included in the HE-SIG-B content channel in combination with the number of BA failures. For instance, after the HE-MU PPDU frame 400 is transmitted by AP 110, AP 110 may not receive BA(s) from one or more of UTs 120, which is considered a BA failure indicating that the one or more UTs 120 were not able to decode HE-SIG-B field 417. In some embodiments, this may be due to a wrong or unsuitable selection of HE-SIG-B MCS value (e.g. a very high HE-SIG-B MCS value). As a result, in some embodiments, AP 110 may adjust the HE-SIG-B MCS values based on the number of BA failures. To make such adjustments, in some embodiments, AP 110 may monitor the number of BA failures and calculate an average number of BA failures across all UTs 120 for which information is included in the HE-SIG-B content channel. The general approach of mapping DL MU MCS Metric ranges to HE-SIG-B MCS values shown in FIG. 10 may also be used here as well. As such, AP 110 may assign default values to v₁, v₂, w₁, w₂, w₃ and subsequently, as described above, adjust or adapt w₁, w₂, w₃ in the corresponding HE-SIG-B MCS functions based on the number of BA failures averaged across all UTs 120 (referred to as “avg-num-BA-fail”).

For example, for a low number of BA failures, AP 110 may increase the HE-SIG-B MCS value. In some embodiments, AP 110 may have (e.g., programmable, defined, etc.) a first threshold of Th-BA-fail₁ and increment HE-SIG-B MCS value by 1 if 0<avg-num-BA-fail<Th-BA-fail₁. In some embodiments, AP 110 may also define a maximum HE-SIG-B MCS value, such as 5, so that the HE-SIG-B MCS value is not incremented past a certain number.

AP 110 may, in some embodiments, also have a second threshold of Th-BA-fail₂ such that for Th-BA-fail₁=<avg-num-BA-fail<Th-BA-fail₂, AP 110 may not change HE-SIG-B MCS value. In such embodiments, an average number of BA failures in the range described above may be indicative of at least a somewhat appropriate HE-SIG-B MCS value that may, therefore, not need any adjustments.

In some embodiments, however, for a large number of BA failures, AP 110 may decrease the HE-SIG-B MCS value to enable more reliable decoding. In such embodiments, an avg-num-BA-fail of higher than Th-BA-fail₂ (avg-num-BA-fail>=Th-BA-fail₂) may be indicative of a HE-SIG-B MCS value that is too high. As a result, in such embodiments, AP 110 may then lower the HE-SIG-B MCS value, for example, by 1. Accordingly, depending on where the average number of BA failures falls in the ranges above, the HE-SIG-B MCS value may be kept the same or adjusted upwards or downwards. It is important to note that the thresholds described above are merely exemplary and, therefore, should not be construed as to limit the present disclosure. For instance, instead of defining two thresholds of Th-BA-fail₁ and Th-BA-fail₁, in some embodiments, three or more thresholds may be defined.

Moving now to FIG. 11, FIG. 11 illustrates example operations 1100 that an AP (e.g. AP 110) may perform to determine a suitable HE-SIG-B MCS value for the transmission of the HE-SIG-B field 417.

At 1102, operations 1100 start by determining a MCS value for communicating information in a signaling field (e.g. HE-SIG-B field 417) of a frame (e.g., HE-MU-PPDU 400) to a plurality of user terminals (e.g., UTs 120) based on one or more data MCS values for communicating payload data (e.g., HE-Data 420) of the frame to the plurality of user terminals. Using one or more of the embodiments above, AP 110 may determine a MCS value for communicating signaling information in the HE-SIG-B field 417 of HE-MU PPDU frame 400 to UTs 120 based on MCS values used by AP 110 for transmission of data in the HE-Data payload field (HE-Data 420) of HE-MU PPDU, as well as other optional factors, such as the number of UTs 120, and/or the number of BA failures, etc.

At 1104, operations 1100 continue by transmitting the frame to the plurality of user devices or UTs 120 using the determined signaling field MCS value for the signaling field. As described above, in some embodiments, the HE-SIG-B MCS value may be determined based on the DL MU MCS values. In some embodiments, the HE-SIG-B MCS value may be determined based on the DL MU MCS values as well as the number of UTs 120 for which information is included in the HE-SIG-B content channel.

At 1106, operations 1100 optionally continue by adjusting the signaling field MCS value based on feedback received from the plurality of user devices. As described above, in some embodiments, the HE-SIG-B MCS value may be adapted using the DL MU MCS values as well as the number of UTs 120 for which information is included in the HE-SIG-B content channel in combination with the number of BA failures. Accordingly, based on the number of BA failures related to the transmission of the frame using the determined HE-SIG-B MCS value, AP 110 may optionally adjust the HE-SIG-B MCS value to help lower the number of BA failures.

At 1108, operations 1100 optionally continue by transmitting the frame to the plurality of user terminals using the adjusted signaling field MCS value.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor.

For example, means for receiving may be a receiver (e.g., the receiver unit of transceiver 254) and/or an antenna(s) 252 of the user terminal 120 illustrated in FIG. 2 or the receiver (e.g., the receiver unit of transceiver 222) and/or antenna(s) 224 of access point 110 illustrated in FIG. 2. Means for transmitting may be a transmitter (e.g., the transmitter unit of transceiver 254) and/or an antenna(s) 252 of the user terminal 120 illustrated in FIG. 2 or the transmitter (e.g., the transmitter unit of transceiver 222) and/or antenna(s) 224 of access point 110 illustrated in FIG. 2.

Means for processing, means for generating, means for obtaining, means for including, means for determining, means for outputting, and means for performing (e.g., a CCA) may comprise a processing system, which may include one or more processors, such as the RX data processor 270, the TX data processor 288, and/or the controller 280 of the user terminal 120 illustrated in FIG. 2 or the TX data processor 210, RX data processor 242, and/or the controller 230 of the access point 110 illustrated in FIG. 2.

According to certain aspects, such means may be implemented by processing systems configured to perform the corresponding functions by implementing various algorithms (e.g., in hardware or by executing software instructions) described herein.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method of wireless communication, comprising:
determining a signaling field modulation and coding scheme (MCS) value for communicating information in a signaling field of a frame to a plurality of user devices based on one or more data MCS values for communicating payload data of the frame to the plurality of user devices; and
transmitting the frame to the plurality of user devices using the determined signaling field MCS value for the signaling field.

2. The method of claim 1, wherein the signaling field comprises a high-efficiency signal B (HE-SIG-B) field.

3. The method of claim 1, wherein determining the signaling field MCS value comprises:
determining a metric based on the one or more data MCS values;
mapping the metric to the signaling field MCS value based on a mapping of metrics to signaling field MCS values.

4. The method of claim 3, wherein the metric is based on one of a minimum or average of the one or more data MCS values.

5. The method of claim 1, wherein the signaling field MCS value is further determined based on a number of the plurality of user devices.

6. The method of claim 5, wherein the signaling field MCS value is further determined based on a number of acknowledgment message failures for the plurality of user devices.

7. The method of claim 1, wherein the signaling field MCS value is further determined based on a number of acknowledgment message failures for the plurality of user devices.

8. An apparatus, comprising:
a memory comprising executable instructions; and
a processor in data communication with the memory and configured, by executing the executable instructions, to:
determine a signaling field modulation and coding scheme (MCS) value for communicating information in a signaling field of a frame to a plurality of user devices based on one or more data MCS values for communicating payload data of the frame to the plurality of user devices; and
transmit the frame to the plurality of user devices using the determined signaling field MCS value for the signaling field.

9. The apparatus of claim 8, wherein the signaling field comprises a high-efficiency signal B (HE-SIG-B) field.

10. The apparatus of claim 8, wherein the processor is further configured to:
determine a metric based on the one or more data MCS values;
map the metric to the signaling field MCS value based on a mapping of metrics to signaling field MCS values.

11. The apparatus of claim 10, wherein the metric is based on one of a minimum or average of the one or more data MCS values.

12. The apparatus of claim 8, wherein the processor is configured to determine the signaling field MCS value further based on a number of the plurality of user devices.

13. The apparatus of claim 12, wherein the processor is configured to determine the signaling field MCS value further based on a number of acknowledgment message failures for the plurality of user devices.

14. The apparatus of claim 1, wherein the processor is configured to determine the signaling field MCS value further based on a number of acknowledgment message failures for the plurality of user devices.

15. An apparatus, comprising:
means for determining a signaling field modulation and coding scheme (MCS) value for communicating information in a signaling field of a frame to a plurality of user devices based on one or more data MCS values for communicating payload data of the frame to the plurality of user devices; and
means for transmitting the frame to the plurality of user devices using the determined signaling field MCS value for the signaling field.

16. The apparatus of claim 15, wherein the signaling field comprises a high-efficiency signal B (HE-SIG-B) field.

17. The apparatus of claim 15, wherein means for determining the signaling field MCS value comprises:
means for determining a metric based on the one or more data MCS values;
means for mapping the metric to the signaling field MCS value based on a mapping of metrics to signaling field MCS values.

18. The apparatus of claim 17, wherein the metric is based on one of a minimum or average of the one or more data MCS values.

19. The apparatus of claim 15, wherein the signaling field MCS value is further determined based on a number of the plurality of user devices.

20. The apparatus of claim 19, wherein the signaling field MCS value is further determined based on a number of acknowledgment message failures for the plurality of user devices.
